(19) United States
(12) Patent Application Publication
(10) Pub. No.: US 2022/0316552 A1
(43) Pub. Date: Oct. 6, 2022

(54) HELICALLY TOOTHED DRIVE BELT

(71) Applicant: ContiTech Antriebssysteme GmbH, Hannover (DE)

(72) Inventors: Tim Fiss, Hannover (DE); Reinhard Teves, Seelze (DE); Thomas Melz, Hannover (DE); Guevenc Sener, Hannover (DE)

(73) Assignee: ContiTech Antriebssysteme GmbH, Hannover (DE)

(21) Appl. No.: 17/634,576

(22) PCT Filed: Jul. 10, 2020
(86) PCT No.: PCT/EP2020/069679

§ 371 Date: Feb. 11, 2022

(30) Foreign Application Priority Data
Aug. 12, 2019 (DE) 10 2019 212 056.3

(51) Int. Cl. F16G 1/10; F16G 1/28

(52) U.S. Cl. CPC F16G 1/10; F16G 1/28; F16H 7/023

(57) ABSTRACT

A helically toothed drive belt made of elastomeric material having internal tensile cords made of aramid fibers, which tensile cords are arranged in the longitudinal direction of the drive belt, wherein the tensile cords each have two strands made of aramid fibers, wherein each of the strands has a twist and the strands are also twisted around one another to form the tensile cord, and the outside diameter of the tensile cord is less than 0.5 mm.

The invention relates to a helically toothed drive belt composed of elastomeric material with internal tensile cords composed of aramid fibers arranged in the longitudinal direction of the drive belt.

Such drive belts are known. Thus, DE 10 2011 002 230 A1, for example, discloses a drive belt having a main body composed of a polymeric material and tensile cords composed of aramid, wherein the strands have a special twist factor. Such drive belts are used in vehicles to drive secondary units subject to relatively light loads. Applications in domestic appliances are also common.

DE 11 2008 001 564 T5 also discloses a helically toothed synchronous belt with a special surface coating composed of silicone oil, in which the tensile cords are produced from a material which contains a mixture of aramid fibers, glass fibers and other fiber materials. The toothed belts disclosed here are provided for small precision machines, e.g. as drive belts for printer carriages in office equipment.

US 2007/0137766 discloses a helically toothed drive belt, the tensile cords of which have structures that are twisted upon themselves and only ever exhibit one direction of twist in the cord. This direction of twist is contrary to the helical toothing in order to keep a tendency for side tracking of the drive belt small. According to the invention, such structures do admittedly exhibit the desired low tendency for side tracking but are inferior in terms of dynamic performance to structures that have cords in the opposite direction of twist.

Toothed belts having tensile cords composed of aramid are also used for industrial applications. These toothed belts are usually composed of polychloroprene rubber and, by virtue of the embedded tensile cords composed of aramid, are distinguished by high longitudinal rigidity and hence a corresponding accuracy of position.

An area of application for drive belts which is now significant comprises power-assisted steering systems in motor vehicles. In modern motor vehicles, electromechanical power-assisted steering systems are increasingly replacing other systems for steering assistance, e.g. electrohydraulic steering systems and, of course, also direct-steering systems. One of the reasons for this is the relatively simple possibility of subjecting such systems to electronic open-loop and closed-loop control, particularly in conjunction with the progressive introduction of driver assistance systems, such as lane keeping systems, parking systems etc. and even systems for autonomous driving.

Electric-motor assistance in such power-assisted steering systems is applied via a transmission either to the steering column or, alternatively, to a steering rod/rack. Hitherto, mechanical direct engagement of the rotation of the steering wheel through to the steering rod has normally also been provided, and therefore the power-assisted steering system, true to its name, transmits only a supporting torque via the various types of transmission. In development to steer-by-wire systems, however, steering is then performed only by means of the electronic sensing of steering movements at the steering wheel and the transmission thereof to correspondingly controlled steering motors.

For power-assisted steering systems, for the autonomous driving functions which are now being introduced and above all for vehicles with steer-by-wire systems, steering is, of course, an absolutely safety-relevant component.

That also applies to the transmissions used there. In addition to the worm gear transmissions that are often used, belt transmissions are also used in electromechanical power-assisted steering systems, in which the supporting torque produced by an electric motor is transmitted from the motor shaft to, for example, a ball screw acting on the rack, via a toothed belt, normally helically toothed, and correspondingly designed gearwheels. Such toothed belts must transmit considerable steering forces and vibrations and must be designed with a high level of safety and redundancy, thus ensuring that there is no risk of damage within the maintenance intervals and maintenance measures. Fundamentally, toothed belts consist of a “substructure”, which has the toothed profile, of at least one ply of tensile cords or strengthening members arranged in the longitudinal direction of the belt, and of the belt backing. Depending on the application, the toothed profile and the belt backing can be provided with further coatings or fabrics.

Normally, use is made here of toothed belts composed of elastomeric material which are provided with tensile cords or strengthening members composed, for example, of glass fibers. Such tensile cords composed of glass fibers have proven their worth by virtue of their low thermal expansion, their temperature resistance and, especially, their dynamic stability, i.e. their tolerance to high-frequency alternating vibrational loads of the kind which can occur in a steering gear. Even under these conditions, toothed belts having tensile cords composed of glass fibers retain their strength for a long time.

Unfortunately, drive belts having tensile cords composed of glass fibers also have a number of disadvantages, which may sometimes considerably limit their use. Tensile cords composed of glass fibers or cords produced from glass fibers have only limited resistance to hydrolysis and therefore lose some of their original strength under the influence of moisture, with the result that there is the risk in the event of load peaks that the belts could be damaged. Although this is not critical as long as the glass fibers are protected from moisture and are surrounded by the elastomeric material, it may be risky if the glass fibers are able to absorb moisture from the environment due to wear, e.g. owing to running up against boundary pulleys.

Another disadvantage is the sensitivity of glass fibers or glass fiber cords to kinking. Such kinking loads may occur when the drive belt is handled incorrectly when being installed or transported, for instance. At the kink in the belts and hence in the glass fiber tensile cords, the required strength can then no longer be guaranteed without reservation.

On the other hand, drive belts having tensile cords composed of aramid fibers have hitherto only been used with relatively slow transmissions with relatively low speeds of revolution, in which therefore the frequency of the pulsating loads and of the load due to alternate bending is relatively low for the aramid-reinforced belt. If the speeds of revolution and hence these load frequencies become too high, a drive belt having tensile cords composed of aramid fibers tends to lose its strength properties after a certain time. For this reason, tension belts having aramid tensile cords in motor vehicles are not installed in the region of the camshafts, not in drives for oil or water pumps and definitely not in steering systems.

When drive belts are used for steering systems, there is therefore a kind of conflict of aims. On the one hand, it would be desirable to dispense with drive belts having tensile cords composed of glass fibers and to replace them with drive belts having tensile members composed of aramid or aramid cords, which are more resistant to moisture and less sensitive to kinking, and, on the other hand, previous constructions of drive belts/tension belts having aramid cords are not particularly well-suited to load frequencies in a steering gear.

It was therefore the object of the invention, overcoming these conflicting aims, to provide a drive belt which is well-suited to high-frequency pulsating and bending loads in a steering gear, which is resistant to hydrolysis, which remains stable under dynamic loads, which is insensitive to kinking and to handling and transportation loads, and which can be produced at low cost in a simple manner and by the conventional methods.

This object is achieved by the features of the main claim. Further advantageous embodiments are contained in the dependent claims. A steering gear having such a drive belt and a suitable method for the production thereof are likewise disclosed.

Surprisingly, it has namely been found that the structural modification according to the invention of the conventional designs of drive belts having tensile cords composed of aramid fibers leads to a drive belt which meets all requirements for use in a steering gear in the best possible way. In this case, the tensile cords of the drive belt according to the invention each have just two strands composed of aramid fibers, wherein each of the strands has a first twist and the strands are also twisted around one another, i.e. entwined, with a second twist to form the tensile cord.

When describing the structure of the tensile cords in the specialist jargon, the twisting of the fiber bundles as such is referred to as the “first twist” and the twisting of the fiber bundles around one another is referred to as the “second twist”.

In this context, the outside diameter of the tensile cords is less than 0.5 mm, and is preferably between 0.3 and 0.4 mm.

In accordance with the definition of DIN 60 900 Part 1, the tensile cords thus form a special type of twine, in which the two strands are formed from twisted aramid yarns. Here, the aramid yarns each consist of a bundle of several hundred twisted aramid filaments or fibers. The diameter of each individual filament or of each individual fiber is about 7-9 μm. The tensile cord formed is thus a linear textile structure consisting of two strands which have a very small diameter of less than 0.5 mm, preferably of 0.3 to 0.4 mm.

The advantage of such a structure of tensile cords and belts is essentially that the fineness and geometry of the strands and of the tensile cords ensures a high strength with respect to stresses in the case of high-frequency loads and alternate bending, which is not possible with other tensile member structures of larger diameter.

In respect of the high strength which is also required in the case of yarns and tensile cords of such a fineness, one advantageous embodiment consists in that the spacing between two adjacent tensile cords, averaged over 10 adjacent tensile cords, is in the region of 1.2 times to 1.7 times the outside diameter of the tensile cord.

One advantageous development consists in that at least one of the strands has a first twist which is greater than 300, preferably greater than 400 (based on the meter, in accordance with DIN 60900 Part 4). Together with the structure of the tensile cords, this results in a considerable increase in the tensile strength of the drive belt without affecting rigidity or the high load capacity at high frequencies.

A further advantageous embodiment consists in that both strands have a first twist which is greater than 300, preferably greater than 400.

By means of such a structure, the strength of the tensile members or cords and hence of the drive belts is increased. A further advantageous embodiment also has the same effect, this embodiment consisting in that the second twist of the strands around one another is greater than 300, preferably greater than 400.

A further advantageous embodiment consists in that, to avoid the tendency of the entire drive belt to twist or side track, the strands of tensile cords situated adjacent to one another in the drive belt are twisted around one another alternately or alternately in groups with an S twist and a Z twist.

A further advantageous embodiment consists in that the elastomeric material substantially comprises polyalphaolefin rubber, preferably in a proportion of more than 60 phr (parts per hundred rubber), in particular ethylene-propylene copolymer (EPM) or ethylene-propylene-diene rubbers (EPDM).

Polyalphaolefin rubbers such as EPDM or EPM have the decisive advantage over polychloroprene or polyurethane of improved low-temperature flexibility and of decisively better resistance to aging. Toothed belts composed of EPDM can be used at temperatures significantly lower than −40° C. They are permanently stable, even at 130° C. Belts composed of HNBR also have a significantly better resistance to all possible grades of oils than EPDM, polychloroprene and polyurethane, and this is advantageous precisely in the range of applications in motor vehicles and, in that context, especially of steering systems.

A further advantageous embodiment consists in that the elastomeric material substantially comprises partially or fully hydrogenated nitrile rubber (HNBR), preferably in a proportion of more than 60 phr (parts per hundred rubber).

A further advantageous embodiment consists in that the elastomeric material is cross-linked using peroxides. In principle, EPDM and HNBR can be cross-linked with resins, with sulfur or by means of peroxides. The use of peroxides for cross-linking leads, particularly in the presence of acrylates, acrylate salts or salts of alpha-beta unsaturated carboxylic acids to vulcanized products which are resistant to high temperatures and, at the same time, dynamically stable, as required in the belt. Sulfur cross-linking results in significantly poorer heat resistance, while resin cross-linking results in poorer dynamic durability.

The “direct cabling” process is particularly suitable for the production of a tensile cord of a drive belt in which both strands have twists which are greater than 300. If the first and second twist involve the same amount of twisting, such a tensile cord can be produced at low cost in just one production step by direct cabling.

Among other areas of application, the drive belt according to the invention is particularly suitable, by virtue of the situation with respect to loads, for use in a steering gear in an electromechanical steering system of a motor vehicle.

The invention will be explained in more detail on the basis of an exemplary embodiment. In the figures:

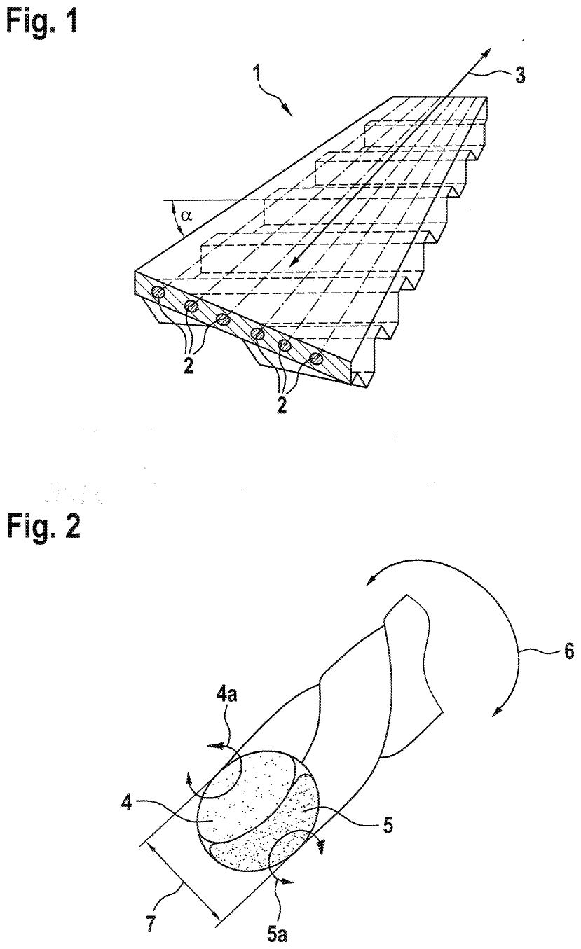

FIG. 1 shows a drive belt according to the invention for a steering gear

FIG. 2 shows a tensile cord of the drive belt shown in FIG. 1 in an enlarged perspective view

FIG. 1 shows a helically toothed drive belt 1 according to the invention for a steering gear, said belt being composed of elastomeric material, namely 75 phr EPDM. The drive belt is provided with internal tensile cords 2 consisting of aramid fibers arranged in the longitudinal direction of the drive belt. The teeth of the drive belt slope at an angle α to the longitudinal direction 3 of the belt.

FIG. 2 shows a tensile cord in an enlarged perspective view only as a schematic diagram. It can be seen here that the tensile cords 2 each have two strands 4, 5.

The strands consist of aramid fibers. Each of the strands has a first twist, which is indicated here only symbolically by the arrows 4a and 5a for the sake of clarity. Arrows at both ends indicate that the direction of twist is not restricted in either case. The strands 4 and 5 as such are also twisted around one another, i.e. entwined, to form the tensile cord 2. The twisting of the strands—the twine—is symbolized by the arrow 6. This twisting 6 of the strands takes place alternately in the form of an S or Z twist with the strands side-by-side. Here, the outside diameter 7 of the tensile cord is 0.35 mm.

Here, based on the meter, in accordance with DIN 60900 Part 4, the first twist of strand 4 in the direction of twist 4a is 450/m, and the first twist of strand 5 in the direction of twist 5a is likewise 450/m. Moreover, the second twist 6 of the strands around one another is likewise 450/m here.

### LIST OF REFERENCE DESIGNATIONS

1 Helically toothed drive belt
2 Tensile cord
3 Longitudinal direction of the drive belt
4 Strand
4a Twist of strand 4
5 Strand
5a Twist of the strand 5
6 Twisting of the strands around one another (twine)
7 Outside diameter of the tensile cord

1-11. (canceled)

12. A helically toothed drive belt comprising elastomeric material having internal tensile cords made of aramid fibers, wherein the tensile cords are arranged in the longitudinal direction of the drive belt, wherein the tensile cords each have two strands made of aramid fibers, wherein each of the two strands has a first twist and the two strands are also twisted around one another with a second twist to form each the tensile cords, and wherein the outside diameter of each of the tensile cords is less than 0.5 mm.

13. The helically toothed drive belt as claimed in claim 12, wherein the outside diameter of each of the tensile cords is between 0.3 mm and 0.4 mm.

14. The helically toothed drive belt as claimed in claim 12, wherein adjacent spacing between the tensile cords, averaged over 10 of the tensile cords adjacently spaced, is in the region of 1.2 times to 1.7 times the outside diameter of each of the tensile cords.

15. The helically toothed drive belt as claimed in claim 12, wherein at least one of the two strands has the first twist which is greater than 300 (in each case based on a meter, in accordance with DIN 60900 Part 4).

16. The helically toothed drive belt as claimed in claim 15, wherein at least one of the two strands has the first twist which is greater than 400 (in each case based on a meter, in accordance with DIN 60900 Part 4).

17. The helically toothed drive belt as claimed in claim 12, wherein both of the strands have the first twist which is greater than 300.

18. The helically toothed drive belt as claimed in claim 17, wherein both of the strands have the first twist which is greater than 400.

19. The helically toothed drive belt as claimed in claim 12, wherein the second twist of the strands around one another is greater than 300.

20. The helically toothed drive belt as claimed in claim 19, wherein the second twist of the strands around one another is greater than 400.

21. The helically toothed drive belt as claimed in claim 12, wherein the two strands are situated adjacent to one another in the drive belt and are twisted around one another alternately with an S twist and a Z twist.

22. The helically toothed drive belt as claimed in claim 12, wherein the two strands are situated adjacent to one another in the drive belt and are twisted around one another alternately in groups with an S twist and a Z twist.

23. The helically toothed drive belt as claimed in claim 12, wherein the elastomeric material comprises polyalphaolefin rubber in a proportion of more than 60 phr (parts per hundred rubber).

24. The helically toothed drive belt as claimed in claim 12, wherein the elastomeric material comprises ethylene-propylene copolymer (EPM) rubber in a proportion of more than 60 phr (parts per hundred rubber).

25. The helically toothed drive belt as claimed in claim 12, wherein the elastomeric material comprises ethylene-propylene-diene (EPDM) rubber in a proportion of more than 60 phr (parts per hundred rubber).

26. The helically toothed drive belt as claimed in claim 12, wherein the elastomeric material comprises partially hydrogenated nitrile rubber (HNBR) in a proportion of more than 60 phr (parts per hundred rubber).

27. The helically toothed drive belt as claimed in claim 12, wherein the elastomeric material comprises fully hydrogenated nitrile rubber (HNBR) in a proportion of more than 60 phr (parts per hundred rubber).

28. The helically toothed drive belt as claimed in claim 12, wherein the elastomeric material is cross-linked using peroxides.

29. The helically toothed drive belt as claimed in claim 12, wherein the elastomeric material comprises ethylene-propylene-diene (EPDM) rubber in a proportion of 75 phr (parts per hundred rubber), wherein the first twist is 450/m, wherein the second twist is 450/m, and wherein the outside diameter of each of the tensile cords is 0.35 mm.

30. A method for producing the tensile cords of the helically toothed drive belt as claimed in claim 12, wherein the tensile cords are each produced in a direct cabling process.

31. A steering gear in an electromechanical steering system of a motor vehicle comprising the helically toothed drive belt as claimed in claim 12.
